(19) United States
(12) Patent Application Publication
(10) Pub. No.: US 2007/0075914 A1
(43) Pub. Date: Apr. 5, 2007

(54) Security antenna apparatus and method

(76) Inventor: Frank Bates, Nokomis, FL (US)

Correspondence Address: Frank Bates, P.O. Box 2288, Nokomis, FL, 34274, US

(21) Appl. No.: 11/351,167

(22) Filed: Feb. 9, 2006

Related U.S. Application Data
(60) Provisional application No. 60/697,811, filed on Jul. 8, 2005.

(51) Int. Cl. H01Q 1/36

(52) U.S. Cl. 343/895; 343/702

(57) ABSTRACT

This invention defines an apparatus and method for holding a portable electronic device whereby ease of use is continued, security is ensured and antenna reception is enhanced. The apparatus combines a metallic antenna inside an elastic spiral cord which attaches a cell phone, or other electronic device, with an attachment mechanism, such as a retaining clip, to a person's secure location, such as a waistband, belt, purse, backpack or other, suitably-shaped, receiving structure. The apparatus stretches approximately 24 inches from the secure location for normal use. If the electronic device is dropped the 24 inch stretched distance will most often prevent the device from being lost or damaged by hitting the ground. Simultaneously, the antenna conductive element within the apparatus will improve radio frequency transmission and reception performance for electronic devices.

This application claims the benefit of U.S. Provisional Patent Application Ser. No. 60/697,811, filed Jul. 8, 2005.

### BACKGROUND OF THE INVENTION

1. Field of the Invention

The present invention relates to security holders/carriers for portable electronic devices, pagers, interactive messaging pagers, cellular or mobile telephones, wireless internet devices, MP3 players, PDAs, or walkie-talkies. More particularly, the present invention relates to a metallic antenna inside an elastic spiral cord where one end is fastened to an article of clothing and the other end is mounted to a portable electronic device for security and increased reception. This invention relates to an antenna for wireless communication devices with an added security holding/carrying feature, FIG. 1.

2. Background of Prior Art of the Invention

U.S. Pat. No. 6,932,309 is a physical apparatus to secure portable electronic devices. This prior art only provides for secure transport of electronic devices. This device can not be secured while in use, additionally it provides no transmission and reception performance features.

U.S. Pat. No. 6,810,237 discloses an antenna conductive element within a lanyard to improve radio frequency transmission and reception performance for wireless communication devices. The limiting factor is this device can not be secured while in use, and provides no additional safety features. This prior art has no security features.

U.S. Pat. No. 5,941,434 provides a secure method to retain a portable electronic device but provides no added security or improved radio frequency transmission and reception performance for wireless communication devices.

### 3. SUMMARY OF THE INVENTION

The object of the present invention is to provide a secure holder with a built in antenna for portable communications devices and data storage devices, such as cellular telephones, wireless internet devices, walkie-talkies, portable digital assistants, MP3 players, and other portable devices. A flexible elastic coil or spring provided with a hook/retaining clip fastener, such that it can be attached to any one; includes an antenna which can be connected to the electronic device with an appropriate attachment mechanism for securing the electronic device for safety when in use and dropped, FIG. 2.

### 4. BRIEF DESCRIPTION OF DRAWINGS

Other objects and advantages of the invention will be more clearly understood by reference to the following description taken in connection with the accompanying drawings, in which the invention can be best understood by:

FIG. 1 depicts an embodiment of the present invention having a hook to secure to one's person such as a waistband, belt, purse, backpack or other, suitably-shaped, receiving structure, an elastic antenna security cord with a typical electronic device antenna plug connection and a typical security cord to attach securely to an electronic device to prevent lose or damage after falling.

FIG. 2 depicts an embodiment of the present invention having an elastic security cord embedded with an antenna illustrating how the device attaches to a person to secure the electronic device while in use 10. If dropped 20 the device is secure from lose or damage 30.

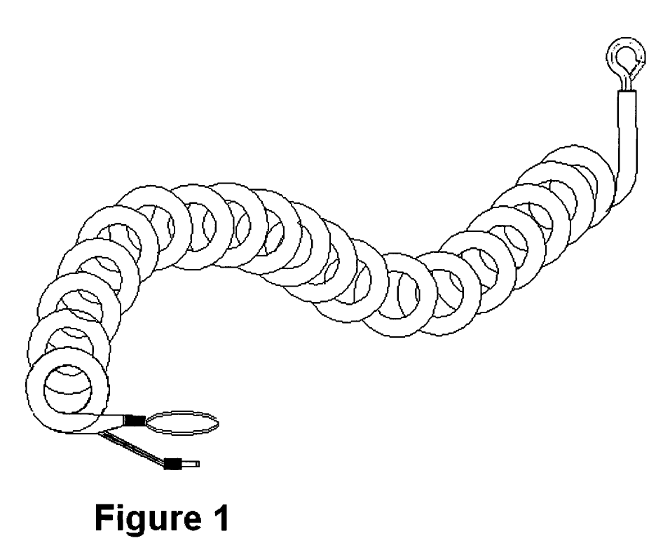

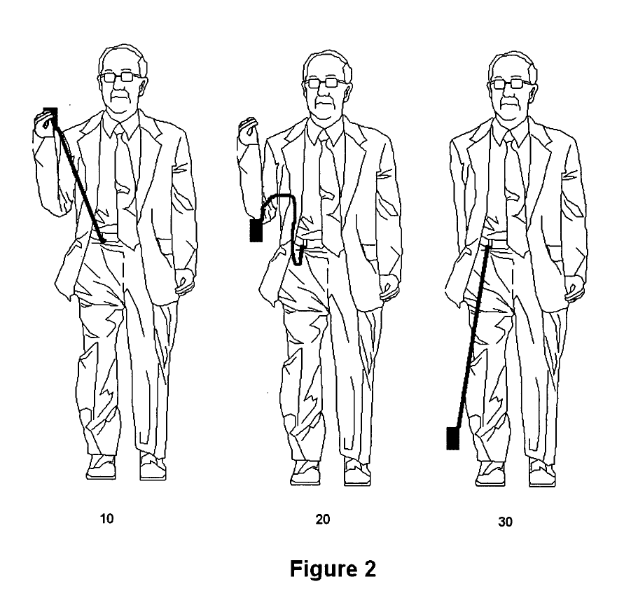

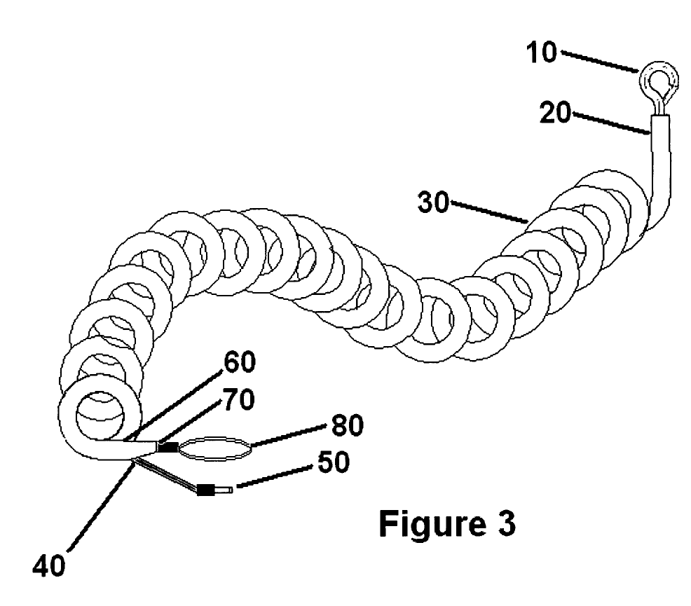

### 5. DETAILED DESCRIPTION OF DRAWING

Referring to FIG. 3 the typical security retaining clip is depicted 10, to secure to one's person, such as a waistband, belt, purse, backpack or other, suitably-shaped, receiving structure. The retaining clip is attached to the spiral elastic antenna security cord 30, at 20. The spiral elastic antenna security cord 30, has a typical antenna plug 50 attached at the opposite end 40 with a typical phone loop 80 with a release clip 70 similarly attached at 60. The typical antenna plug 50 and phone attachment loop 80 may vary with different phone models.

I claim:

1. An apparatus for holding a portable electronic device, comprising:
a. A spiral elastic member;
b. An embedded electronic antenna conductive element has a length that is a function of the frequency range operation of the wireless telephony device for a desired gain;
c. A mounting hardware, or other attachment mechanism, such as a retaining clip to connect to a person's secure location, such as a waistband, belt, purse, backpack or other, suitably-shaped, receiving structure;
d. A electronic device mounting loop, or other attachment mechanism, such as a retaining clip to connect to a portable communications device, a data storage device, such as a cellular telephone, wireless internet device, walkie-talkie, portable digital assistant, MP3 player, and other portable electronic device;
e. A antenna plug suitable to attach to an electronic device antenna for establishing a frequency range operation of the wireless telephony device for a desired gain.

2. The apparatus as recited in claim 1, wherein said spiral elastic member is suitable in length and tension to suspend the electronic device when dropped.

3. The apparatus of claim 1, wherein the antenna conductive element is coupled to the portable communications device, a data storage device, such as a cellular telephone, wireless internet device, walkie-talkie, portable digital assistant, MP3 player, and other portable electronic device to enhance the reception of said device.
